(19) United States
(12) Patent Application Publication
(10) Pub. No.: US 2022/0083213 A1
(43) Pub. Date: Mar. 17, 2022

(54) TOUCH DISPLAY AND METHOD OF CONTROLLING DISPLAY MODE THEREOF

(71) Applicant: E Ink Holdings Inc., HSINCHU (TW)

(72) Inventor: Chung-Wei OU, HSINCHU (TW)

(21) Appl. No.: 17/190,431

(22) Filed: Mar. 3, 2021

(30) Foreign Application Priority Data
Sep. 17, 2020 (TW) 109132111

(51) Int. Cl. G06F 3/0488; G06F 3/041

(52) U.S. Cl. CPC G06F 3/04883; G06F 3/04166

(57) ABSTRACT

A method of controlling display mode for a touch display is provided. In the method, a touch input data from the touch display panel is received. Then, a control module analyzes the touch input data to determine whether the touch display is in a handwriting state. When the control module determines that the touch display is in the handwriting state, the touch display panel is in a handwriting display mode. When the control module determines that the touch display is not in the handwriting state, the touch display panel is in a non-handwriting display mode.

This application claims priority to Taiwan Application Serial Number 109132111, filed Sep. 17, 2020, which is herein incorporated by reference in its entirety.

### BACKGROUND

### Field of Invention

The present disclosure relates to a display and the method of controlling display mode thereof. More particularly, the present disclosure relates to a touch display and the method of controlling display mode thereof.

### Description of Related Art

At present, some electronic paper has tactile control function, so that a user not only can read a text and a picture shown by the electronic paper, but also can write on the electronic paper to input a text or a picture. Hence, a conventional electronic paper can provide the functions of writing and drawing to a user. However, the conventional electronic paper perhaps may show defects, for example, flickers, latency, or broken handwriting lines when the user is writing on the electronic paper.

### SUMMARY

At least one embodiment of the disclosure provides a method of controlling display mode, which can help to reduce or to prevent the abovementioned defects.

Another embodiment of the disclosure provides a touch display, which employs the abovementioned method of controlling display mode.

The method of controlling display mode according to at least one embodiment of the disclosure is used for the touch display, where the touch display includes a touch display panel and a control module electrically connected to touch display panel. In the abovementioned method of controlling display mode, a touch input data is received from the touch display panel. Next, the control module analyzes the touch input data, so as to determine whether the touch display is in a handwriting state. When the control module determines that the touch display is in the handwriting state, the touch display panel is in a handwriting display mode. When the control module determines that the touch display is not in the handwriting state, the touch display panel is in a non-handwriting display mode.

The touch display according to at least one embodiment of the disclosure includes the touch display panel and the control module, where the control module electrically connected to touch display panel. When the object touches the touch display panel, the touch display panel generates the touch input data. The control module is used for analyzing the touch input data, so as to determine whether the touch display is in the handwriting state. When the touch display is determined in the handwriting state, the control module lets the touch display panel be in the handwriting display mode. When the touch display is determined not in the handwriting state, the control module lets the touch display panel be in the non-handwriting display mode.

The control module can analyze the touch input data generated by the touch display panel to determine whether the touch display is in the handwriting state, thereby making the touch display panel in an appropriate display mode (i.e., handwriting display mode or non-handwriting display mode), so that it is helpful to reduce or prevent defects, for example, flickers, latency, or broken handwriting lines.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram of a touch display according to at least one embodiment of the disclosure.

FIG. 2A is a flow chart of a method of controlling display mode according to at least one embodiment of the disclosure.

FIG. 2B further illustrates a flow chart of the step S210 in FIG. 2A.

FIG. 2C is a schematic view of the operation of the touch display panel in the handwriting display mode in FIG. 1.

FIG. 2D is a schematic view of the touch input data generated by the touch display panel in FIG. 2C.

FIG. 2E is a schematic view of the operation of the touch display panel in the non-handwriting display mode in FIG. 1.

FIG. 2F is a schematic view of the touch input data generated by the touch display panel in FIG. 2E.

FIG. 3 is a flow chart of a method of controlling display mode according to another embodiment of the disclosure.

FIG. 4 is a flow chart of a method of controlling display mode according to another embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

In the following description, in order to clearly present the technical features of the present disclosure, the dimensions (such as length, width, thickness, and depth) of elements (such as layers, films, substrates, and areas) in the drawings will be enlarged in unequal proportions. Therefore, the description and explanation of the following embodiments are not limited to the sizes and shapes presented by the elements in the drawings, but should cover the sizes, shapes, and deviations of the two due to actual manufacturing processes and/or tolerances. For example, the flat surface shown in the drawings may have rough and/or non-linear characteristics, and the acute angle shown in the drawings may be round. Therefore, the elements presented in the drawings in this case are mainly for illustration, and are not intended to accurately depict the actual shape of the elements, nor are they intended to limit the scope of patent applications in this case.

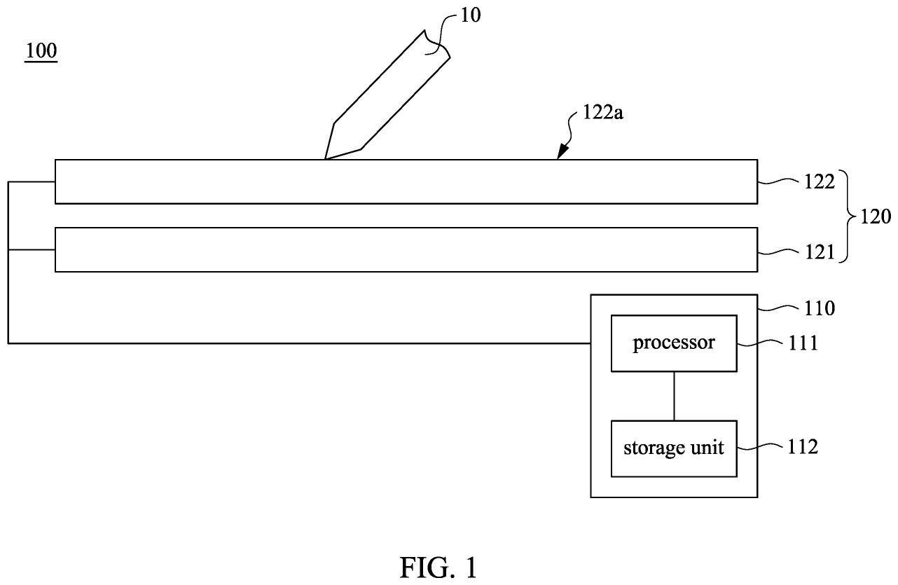

FIG. 1 is a block diagram of a touch display according to at least one embodiment of the disclosure. Referring to FIG. 1, the touch display 100 includes a control module 110 and a touch display panel 120, in which the control module 110 is electrically connected to touch display panel 120. The touch display panel 120 can detect the contact of the object 10, so that the touch display 100 can further sense the position and the movement of the object 10, in which the object 10 may a finger or a stylus, and the object 10 shown in FIG. 1 is a stylus, for example.

In the embodiment as shown in FIG. 1, the touch display panel 120 may be an out-cell touch display panel and include a reflective display panel 121 and a touch panel 122, in which the touch panel 122 can be adhered to the reflective display panel 121, so that the touch panel 122 can be attached to the reflective display panel 121. The reflective display panel 121 may be a display apparatus, which can keep showing images without electric power, for example, an electrowetting display panel or an electrophoretic display panel, etc.

However, it is necessary to note that the touch display panel 120 also may be an on-cell or in-cell touch display panel in other embodiment. That is, the reflective display panel 121 and the touch panel 122 can be integrated into a single display panel. Hence, the touch display panel 120 shown in FIG. 1 is illustrated for example, and the touch display panel 120 is not limited only to the out-cell touch display panel.

When the object 10 touches the tactile control surface 122a of the touch panel 122, the touch panel 122 can generate a touch input data, in which the touch input data may have a plurality of digital signals which are represented by 0 and 1. The control module 110 is used for analyzing the touch input data to obtain the signals of the position and the movement of the object 10. Hence, according to the touch input data generated by the touch display panel 120, the control module 110 can find the position and the movement both of the object 10 on the tactile control surface 122a, so that the touch display 100 can sense both the position and the movement of the object 10.

In the present embodiment, the control module 110 can include a processor 111 and a storage unit 112, in which the processor 111 that may be a microprocessor is electrically connected to the touch panel 122, the reflective display panel 121, and the storage unit 112. The storage unit 112 can store the touch input data, and the processor 111 can read the touch input data from the storage unit 112 to analyze the touch input data, thereby sensing the position and the movement both of the object 10.

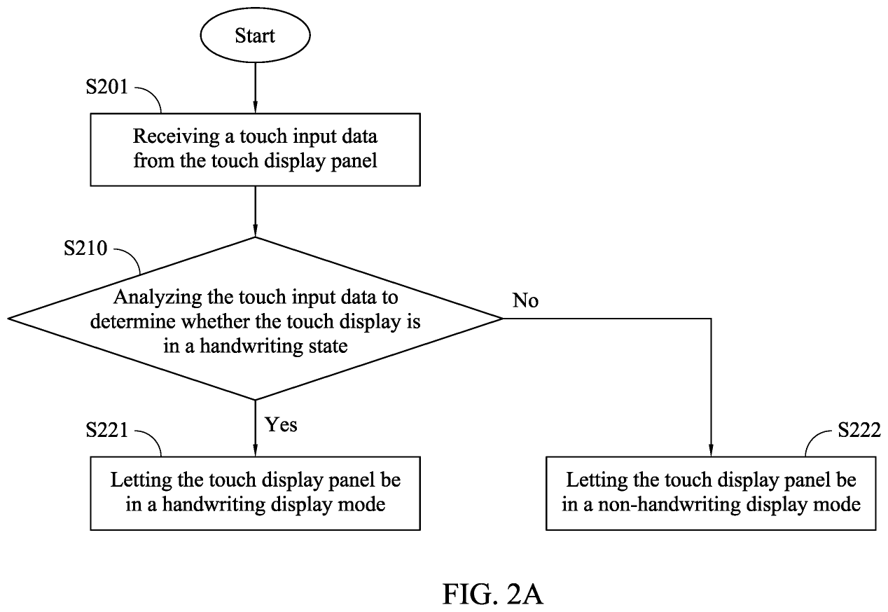

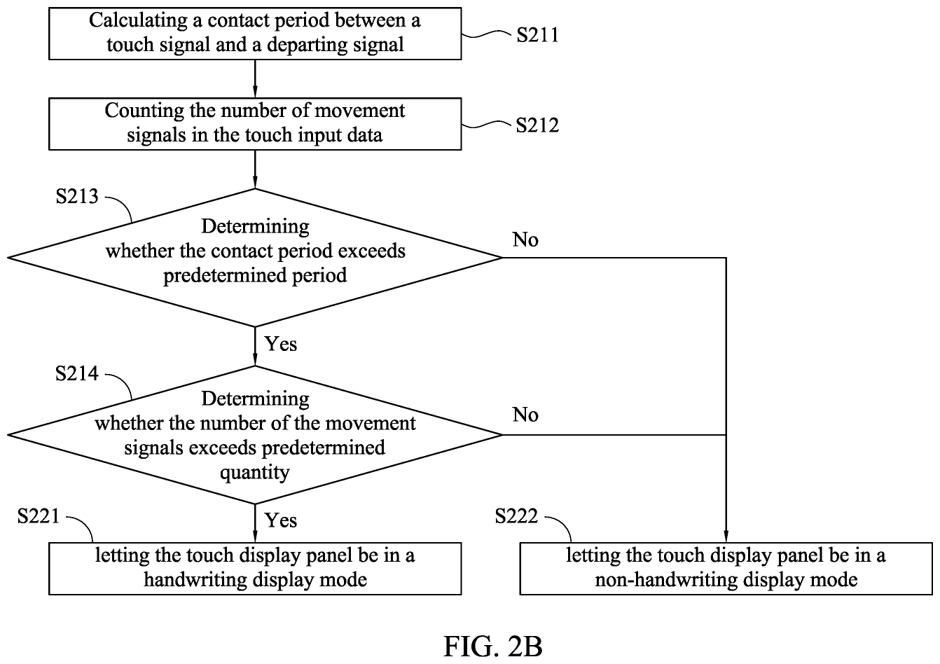

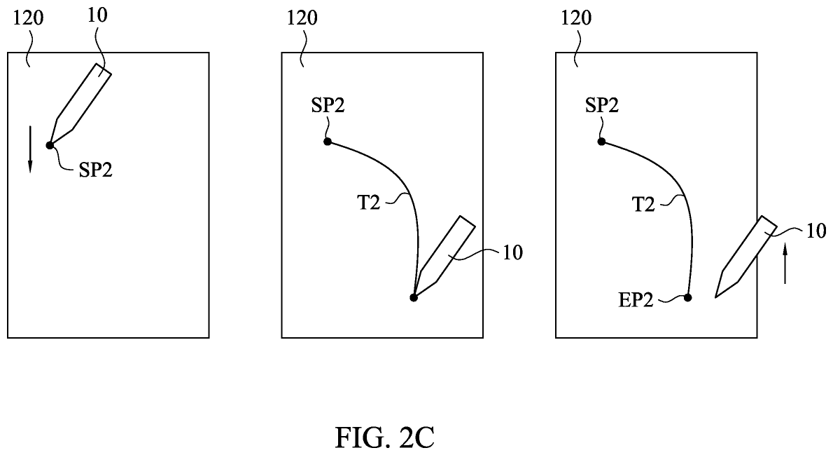

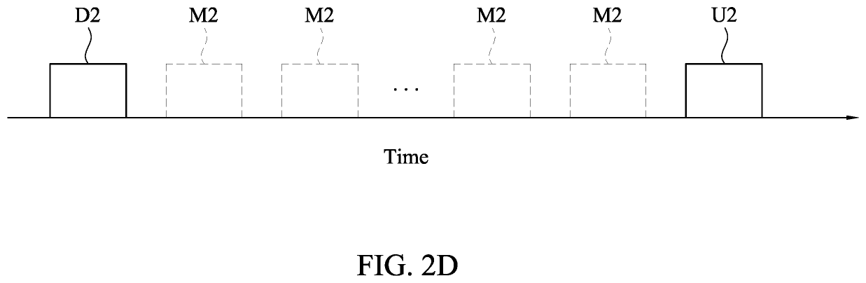

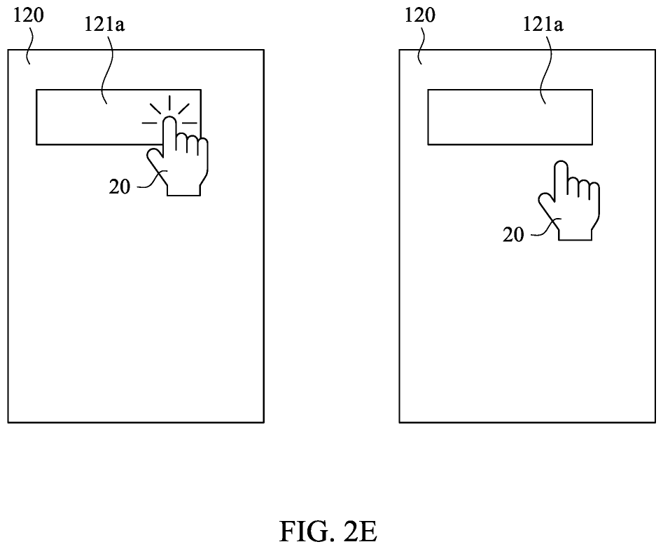

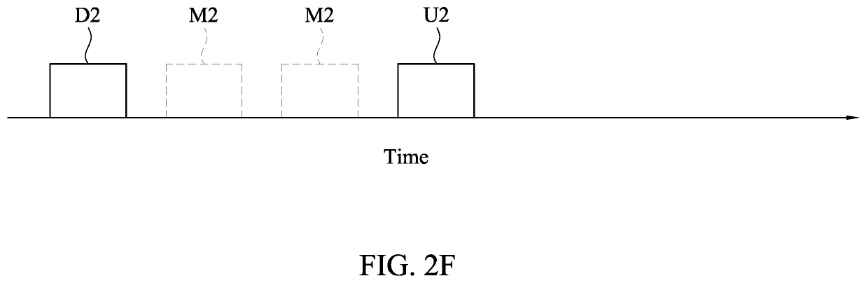

FIG. 2A is a flow chart of a method of controlling display mode according to at least one embodiment of the disclosure. Referring to FIGS. 1 and 2A, the method of controlling display mode disclosed in FIG. 2A can be used in the touch display 100. That is, the touch display 100 in FIG. 1 can execute the method of controlling display mode in FIG. 2A, and the storage unit 112 can store a software for executing the method of controlling display mode. In the embodiment shown in FIG. 2A, the analysis of the touch input data by the control module 110 not only can sense the position and the movement both of the object 10, but also can determine whether a user uses the handwriting function of the touch display 100. In other words, the processor 111 of the control module 110 can determine whether the touch display 100 is in a handwriting state according to the touch input data.

In the method of controlling display mode shown in FIG. 2A executed by the touch display 100, first, a step S201 is executed, that is to say, the control module 110 receives the touch input data from the touch display panel 120. When the object 10 touches the tactile control surface 122a of the touch panel 122, the touch panel 122 can generate the touch input data and input the touch input data to the control module 110, so that the control module 110 can receive the touch input data, in which the touch input data can be stored in the storage unit 112 at first and be provided for reading and analysis.

Next, a step S210 is executed, that is to say, the control module 110 analyzes the touch input data, so as to determine whether the touch display 100 is in the handwriting state. When the control module 110 determines that the touch display 100 is in the handwriting state, a step S221 is executed, that is to say, the control module 110 lets the touch display panel 120 be in the handwriting display mode. When the touch display panel 120 is in the handwriting display mode, the reflective display panel 121 can show the position and the moving track both of the object 10 on the touch panel 122 immediately.

For example, the touch display panel 120 has a plurality of pixels, and the reflective display panel 121 updates corresponding some of the pixels only depending on both the position and the moving track of the object 10, and does not update all of the pixels, so as to help to reduce or prevent defects, for example, flickers, latency, or broken handwriting lines, in which the control module 110 can input image data to the reflective display panel 121 by using universal serial bus (USB), for example.

When the control module 110 determines that the touch display 100 is not in the handwriting state, a step S222 is executed, that is to say, the control module 110 lets the touch display panel 120 be in the non-handwriting display mode, in which the non-handwriting display mode is a read mode, for example. When the touch display panel 120 is in the non-handwriting display mode (e.g., read mode), the control module 110 can input image data to the reflective display panel 121 by using mobile industry processor interface (MIPI), for example, so as to update all of the pixels of the reflective display panel 121.

The control module 110 can analyze the touch input data generated by the touch display panel 120 to determine whether the touch display 100 is in the handwriting state, so that the touch display panel 120 can be in an appropriate display mode (i.e., handwriting display mode or non-handwriting display mode). Accordingly, the touch display 100 can enter the appropriate display mode automatically depending on the tactile operation mode of the user, so as to help to reduce or prevent defects, for example, flickers, latency, or broken handwriting lines.

FIG. 2B further illustrates a flow chart of the step S210 in FIG. 2A. Referring to FIGS. 1 and 2B, the step S210 in FIG. 2A, in which the touch input data is analyzed to determine whether the touch display 100 is in the handwriting state, has a variety of specific means, and FIG. 2B discloses at least one of the specific means. However, it is necessary to note that the step S210 disclosed in FIG. 2B is just one of the variety of specific means, so the specific means of the step S210 is not limited to FIG. 2B. Specifically, after the control module 110 receives the touch input data from the touch display panel 120 (i.e., the step S201 shown in FIG. 2A), a step S211 is executed, that is to say, the processor 111 of the control module 110 calculates a contact period between the touch signal and the departing signal.

Referring to FIGS. 1, 2C, and 2D, FIG. 2C is a schematic view of the operation of the touch display 100 in the handwriting display mode, whereas FIG. 2D discloses the touch input data generated by the touch display panel 120 in FIG. 2C. When the object 10 just touches the tactile control surface 122a of the touch display panel 120, the tactile control surface 122a of the touch display panel 120 generates a touch signal D2 at first. Taking the left part of FIG. 2C for example, when the user uses the object 10 to write on the touch display panel 120, the object 10 touches a point SP2 of the touch display panel 120 at first, in which the point SP2 is in the tactile control surface 122a. At this time, the touch panel 122 generates the touch signal D2 because the object 10 touches the point SP2.

The touch panel 122 can generate at least one movement signal M2 (represented by the dashed line in FIG. 2D) when the object 10 continues to touch the tactile control surface 122a of the touch display panel 120 and moves on the tactile control surface 122a to form a moving track T2 starting from the point SP2 after touching the point SP2. The number of the movement signals M2 correlates with the path length of the moving track T2. The longer the path length of the moving track T2 is, the more the number of the generated movement signals M2 is.

When the object 10 in contact with the touch display panel 120 just leaves the touch display panel 120 from a point EP2 of the tactile control surface 122a, the touch panel 122 generates a departing signal U2, and the reflective display panel 121 can show the moving track T2 which starts from the point SP2 and ends at the point EP2. The touch input data has the digital signals which are represented by 0 and 1, so that the touch signal D2, the movement signal M2, and the departing signal U2 are also digital signals. Taking FIG. 2D for example, all of the touch signal D2, the movement signal M2, and the departing signal U2 substantially may be square wave signals with logic potential “1”.

Referring to FIGS. 1, 2B, and 2D, after the step S211, a step S212 can be executed, that is to say, the processor 111 of the control module 110 counts the number of the movement signals M2 in the touch input data. Afterwards, a step S213 is executed, that is to say, the processor 111 of the control module 110 determines whether the contact period calculated by the step S211 exceeds a predetermined period, in which the predetermined period can be selected as an appropriate time depending on the different types of the touch displays 100. The predetermined period can range between 50 ms (millisecond) and 200 ms, but the predetermined period is not limited to the abovementioned range.

The contact period between the touch signal D2 and the departing signal U2 is substantially equivalent to the period that the object 10 continuously and uninterruptedly touches the tactile control surface 122a of the touch display panel 120. When the contact period does not exceed the predetermined period, that is, it is less than the predetermined period, it means that the period that the object 10 continues to touch the touch display panel 120 is very short, so that the object 10 difficultly causes a moving track which can be sensed on the tactile control surface 122a, thereby difficultly generating the movement signal M2, even generating no movement signal M2.

Accordingly, once the processor 111 determines that the contact period does not exceed the predetermined period (i.e., the contact period is less than the predetermined period), the processor 111 determines that the touch display 100 is not in the handwriting state and executes the step S222. That is, the touch display panel 120 is in the non-handwriting display mode. On the contrary, when the contact period exceeds the predetermined period, it means that the period that the object 10 continues to touch the touch display panel 120 is enough to cause the movement signal M2. At this time, the processor 111 of the control module 110 can execute a step S214 to further determine whether the number of the movement signals M2 exceeds the predetermined quantity. Similar to the predetermined period, the predetermined quantity can be selected as an appropriate quantity depending on the different types of the touch displays 100, in which the predetermined quantity can range between 5 and 10, but the predetermined quantity is not limited to the abovementioned range.

Referring to FIGS. 1, 2B, 2E, and 2F, when not only the contact period exceeds the predetermined period, but also the number of the movement signals M2 does not exceed the predetermined quantity, the processor 111 determines that the touch display 100 is not in the handwriting state and executes the step S222, that is to say, the touch display panel 120 is in the non-handwriting display mode.

Taking FIGS. 2E and 2F for example, when the user uses a finger 20 for a long press on an icon 121a shown by the touch display panel 120, the contact period exceeds the predetermined period obviously. However, the finger 20 only long presses the icon 121a and does not obviously move on the tactile control surface 122a of the touch display panel 120, so the touch display panel 120 generates very few movement signal M2 (e.g., two movement signals M2 as shown in FIG. 2F), even generates no movement signal M2. Accordingly, based on the situation that the number of the movement signals M2 does not exceed the predetermined quantity, the control module 110 can determine that the touch display 100 is not in the handwriting state and execute the step S222.

Referring to FIGS. 1, 2B, 2C, and 2D, when not only the contact period exceeds the predetermined period, but also the number of the movement signals M2 exceeds the predetermined quantity, the processor 111 determines that the touch display 100 is in the handwriting state and executes the step S221, that is to say, the control module 110 lets the touch display panel 120 be in the handwriting display mode. Taking FIG. 2C and FIG. 2D for example, the user uses the object 10 to touch the point SP2 of the touch display panel 120 at first, and then the object 10 moves on the tactile control surface 122a. Afterwards, the object 10 leaves the touch display panel 120 from the point EP2, so as to form the moving track T2. Hence, the touch display panel 120 can generate the movement signals M2 whose number exceeds the predetermined quantity, so that the control module 110 determines that the touch display 100 is in the handwriting state and executes the step S221.

It is worth mentioning that the steps S211 and S213 both in the embodiment shown in FIG. 2B can be omitted. In other words, the method of controlling display mode can include the step of counting the number of the movement signals M2 and omit the step of calculating the contact period in other embodiment. Hence, the control module 110 can directly determine that the touch display 100 is not in the handwriting state and execute the step S222 when the number of the movement signals M2 is below the predetermined quantity. The control module 110 can directly determine that the touch display 100 is in the handwriting state and execute the step S221 when the number of the movement signals M2 exceeds the predetermined quantity.

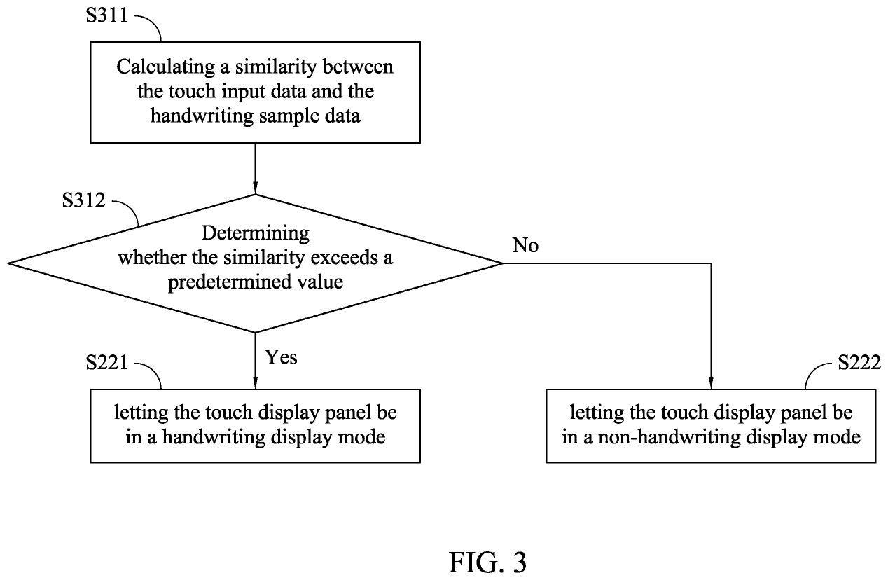

FIG. 3 is a flow chart of a method of controlling display mode according to another embodiment of the disclosure, in which the control method in FIG. 3 is also suitable for the touch display 100 in FIG. 1. Referring to FIGS. 1 and 3, the embodiment shown in FIG. 3 is similar to the previous embodiment, in which the main difference between both of the abovementioned embodiments is different means of analyzing the touch input data (i.e., the step S210). The control method of FIG. 3 uses a comparison between a sample data prestored in the storage unit 112 and the touch input data to determine whether the touch display 100 is in the handwriting state.

Specifically, the storage unit 112 of the control module 110 can prestore a handwriting sample data, in which the handwriting sample data is similar to the touch input data as shown in FIG. 2D and includes the movement signals M2 whose number exceeds the predetermined quantity. After the control module 110 receives the touch input data (i.e., the step S201 in FIG. 2A), a step S311 is executed, that is to say, the control module 110 calculates a similarity between the touch input data and the handwriting sample data.

In the step S311, the control module 110 can use string matching algorithms or pattern matching algorithms to calculate the similarity. Next, a step S312 is executed, that is to say, the processor 111 of the control module 110 determines whether the similarity exceeds the predetermined value. The predetermined value can range between 80% and 100%, for example. However, the predetermined value can be adjusted depending on the different types of the touch displays 100, so the predetermined value is not limited to the abovementioned range. When the similarity obtained by the step S311 exceeds the predetermined value, the processor 111 determines that the touch display 100 is in the handwriting state and executes the step S221. On the contrary, when the similarity is below the predetermined value, the processor 111 determines that the touch display 100 is in the non-handwriting state and executes the step S222.

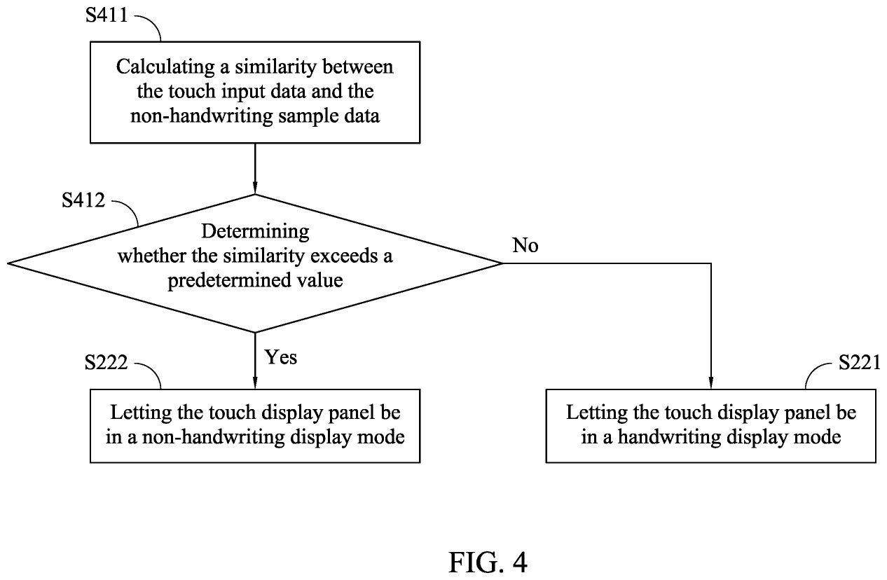

FIG. 4 is a flow chart of a method of controlling display mode according to another embodiment of the disclosure. Referring to FIG. 4, the control method shown in FIG. 4 is similar to that in FIG. 3, and the only difference between the abovementioned embodiments in FIGS. 3 and 4 is the different sample data for comparison with the touch input data. Specifically, a non-handwriting sample data is used for comparison with the touch input data in the present embodiment, in which the storage unit 112 of the control module 110 prestores the non-handwriting sample data. The non-handwriting sample data can be similar to the touch input data as shown in FIG. 2F and include at least one movement signal M2 whose number is below the predetermined quantity.

After the control module 110 receives the touch input data (i.e., the step S201 in FIG. 2A), a step S411 is executed, that is to say, the processor 111 of the control module 110 calculates a similarity between the touch input data and the non-handwriting sample data. In the step S411, the control module 110 also can use string matching algorithms or pattern matching algorithms to calculate the similarity.

Next, a step S412 is executed, that is to say, the control module 110 determines whether the similarity exceeds the predetermined value. When the similarity obtained by the step S311 exceeds the predetermined value, the control module 110 determines that the touch display 100 is in the non-handwriting state and executes the step S222. On the contrary, when the control module 110 determines that the similarity is below the predetermined value, the processor 111 determines that the touch display 100 is in the handwriting state and executes the step S221.

Consequently, in the touch display according to at least one embodiment of the disclosure, the control module can analyze the touch input data generated by the touch display panel, so as to determine whether the user is writing on the touch display panel, thereby determining whether the touch display is in the handwriting state. Afterwards, according to the situation which the touch display is in, the touch display panel can automatically employ the appropriate display mode (i.e., the handwriting display mode or the non-handwriting display mode) to display or to show images, thereby helping to reduce or prevent defects, for example, flickers, latency, or broken handwriting lines.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A method of controlling display mode, used for a touch display, wherein the touch display comprises a touch display panel and a control module electrically connected to the touch display panel, the method of controlling display mode comprising:
receiving a touch input data from the touch display panel;
letting the control module analyze the touch input data to determine whether the touch display is in a handwriting state;
when the control module determines that the touch display is in the handwriting state, letting the touch display panel be in a handwriting display mode; and
when the control module determines that the touch display is not in the handwriting state, letting the touch display panel be in a non-handwriting display mode.

2. The method of controlling display mode of claim 1, wherein the touch display panel generates at least one movement signal when an object touches the touch display panel and moves on the touch display panel,
wherein the steps of the control module analyzing the touch input data comprise:
counting a number of the at least one movement signal in the touch input data;
when the number of the at least one movement signal is less than a predetermined quantity, determining that the touch display is not in the handwriting state; and
when the number of the at least one movement signal exceeds the predetermined quantity, determining that the touch display is in the handwriting state.

3. The method of controlling display mode of claim 2, wherein the touch display panel generates a touch signal when the object just touches the touch display panel;
wherein the touch display panel generates a departing signal when the object in contact with the touch display panel just leaves the touch display panel,
wherein the steps of the control module analyzing the touch input data further comprise:
calculating a contact period between the touch signal and the departing signal; and
when the contact period is less than a predetermined period, determining that the touch display is not in the handwriting state.

4. The method of controlling display mode of claim 3, wherein the steps of the control module analyzing the touch input data further comprise:
determining that the touch display is not in the handwriting state when the contact period exceeds the predetermined period, and the number of the at least one movement signal does not exceed the predetermined quantity; and
determining that the touch display is in the handwriting state when the contact period exceeds the predetermined period, and the number of the at least one movement signal exceeds the predetermined quantity.

5. The method of controlling display mode of claim 1, wherein the steps of the control module analyzing the touch input data comprise:
calculating a similarity between the touch input data and a handwriting sample data;
determining the touch display is in the handwriting state when the similarity exceeds a predetermined value; and
determining the touch display is in the non-handwriting state when the similarity is below the predetermined value.

6. The method of controlling display mode of claim 5, wherein calculating the similarity comprises string matching algorithms or pattern matching algorithms.

7. The method of controlling display mode of claim 1, wherein the steps of the control module analyzing the touch input data comprise:
calculating a similarity between the touch input data and a non-handwriting sample data;
determining the touch display is in the non-handwriting state when the similarity exceeds a predetermined value; and
determining the touch display is in the handwriting state when the similarity is below the predetermined value.

8. The method of controlling display mode of claim 7, wherein calculating the similarity comprises string matching algorithms or pattern matching algorithms.

9. The method of controlling display mode of claim 1, wherein the touch display panel having a plurality of pixels updates corresponding some of the pixels depending on both a position and a moving track of an object.

10. A touch display, comprising:
a touch display panel, generating a touch input data when an object touching the touch display panel;
a control module, electrically connected to the touch display panel and capable of analyzing the touch input data, so as to determine whether the touch display is in a handwriting state;
wherein when the touch display is determined to be in the handwriting state, the control module lets the touch display panel be in a handwriting display mode; and
when the touch display is determined not to be in the handwriting state, the control module lets the touch display panel be in a non-handwriting display mode.

11. The touch display of claim 10, wherein when the object in contact with the touch display panel moves on the touch display panel, the touch display panel generates at least one movement signal, and the control module counts a number of the at least one movement signal in the touch input data;
wherein the control module determines that the touch display is not in the handwriting state when the number of the at least one movement signal is less than a predetermined quantity; and
wherein the control module determines that the touch display is in the handwriting state when the number of the at least one movement signal exceeds the predetermined quantity.

12. The touch display of claim 11, wherein the touch display panel generates a touch signal when the object just touches the touch display panel;
wherein the touch display panel generates a departing signal when the object in contact with the touch display panel just leaves the touch display panel;
wherein the control module calculates a contact period between the touch signal and the departing signal,
wherein the control module determines that the touch display is not in the handwriting state when the contact period is less than a predetermined period.

13. The touch display of claim 12, wherein the control module determines that the touch display is not in the handwriting state when the contact period exceeds the predetermined period, and the number of the at least one movement signal is below the predetermined quantity; and
wherein the control module determines that the touch display is in the handwriting state when the contact period exceeds the predetermined period, and the number of the at least one movement signal exceeds the predetermined quantity.

14. The touch display of claim 10, wherein the control module stores a handwriting sample data and is capable of calculating a similarity between the touch input data and the handwriting sample data;
wherein the touch display is determined to be in the handwriting state when the similarity exceeds a predetermined value; and
wherein the touch display is determined to be in the non-handwriting state when the similarity is below the predetermined value.

15. The touch display of claim 14, wherein the control module calculates the similarity by using string matching algorithms or pattern matching algorithms.

16. The touch display of claim 10, wherein the control module stores a non-handwriting sample data and is capable of calculating a similarity between the touch input data and the non-handwriting sample data;
wherein the touch display is determined to be in the non-handwriting state when the similarity exceeds a predetermined value; and
wherein the touch display is determined to be in the handwriting state when the similarity is below the predetermined value.

17. The touch display of claim 16, wherein the control module calculates the similarity by using string matching algorithms or pattern matching algorithms.
